(19) United States
(12) Patent Application Publication
(10) Pub. No.: US 2015/0029959 A1
(43) Pub. Date: Jan. 29, 2015

(54) METHOD AND SYSTEM FOR ALLOCATING RADIO CHANNEL

(71) Applicants: Bin DA, Beijing (CN); Wei WANG, Beijing (CN); Haihua YU, Beijing (CN); Yindong ZHANG, Beijing (CN); Linju YANG, Beijing (CN)

(72) Inventors: Bin DA, Beijing (CN); Wei WANG, Beijing (CN); Haihua YU, Beijing (CN); Yindong ZHANG, Beijing (CN); Linju YANG, Beijing (CN)

(73) Assignee: RICOH COMPANY, LTD., Tokyo (JP)

(21) Appl. No.: 14/338,494

(22) Filed: Jul. 23, 2014

(30) Foreign Application Priority Data
Jul. 26, 2013 (CN) 201310319684.7

(51) Int. Cl. H04W 72/08; H04W 72/12

(52) U.S. Cl. CPC H04W 72/082; H04W 72/1231
USPC 370/329

(57) ABSTRACT

A method and a system for allocating a radio channel are disclosed. The method includes the steps of determining one or more priority radio channels exclusively for transmitting priority data; determining whether there is a condition of allocating the one or more priority radio channels in an organized wireless group (OWG); and allocating one of the one or more priority radio channels, when the one or more priority radio channels are empty.

### BACKGROUND OF THE INVENTION

1. Field of the Invention

The present invention generally relates to a method and a system for allocating a radio channel, and specifically, a method and a system for allocating a radio channel that transmits data at a high speed.

2. Description of the Related Art

When using dense radio channels, in the environment of Wi-Fi 802.11b/g of 2.4G communication technology or Wi-Fi-Direct, the commonly used channels with a non-overlapping frequency band are the first channel (2412 MHz), the sixth channel (2437 MHz) and the eleventh channel (2462 MHz). In the currently developing 5G communication technology, there are four available channels of 5.725-5.825 GHz. With the increase of the number of the mobile equipments sharing the same channel, the co-channel interference between the mobile equipments also increases. Accordingly, when it is necessary to transmit important data efficiently, the data transmission performance on the channels may not be guaranteed. Therefore, it is necessary to provide a method for controlling the interference and transmitting data efficiently when sharing the same channel by rationally allocating the channels.

In the Patent Applications by Qualcomm, US20120020234A1, US20110282989A1, US20110255450A1, US20110243010A1, US20090111506A1, WO2011143496A1, WO2011130626A1, WO2011123799A1 and WO2012015698A1, some solutions for controlling channel interference are provided. However, in these solutions, the access and adjustment are performed by a spectrum gap, and channels are allocated only to a single mobile equipment.

In another U.S. Patent Application Publication US2007195721A1 published on Aug. 23, 2007, for which the applicants are Floyd Backs, Gray Vacon, et al., and the title is “Program for distributed channel selection, power adjustment and load balancing decision in a wireless network”, a method for performing automatic channel selection on the side of an access point to maximize the channel utilization rate is disclosed. In such application, a power control of the access point is performed to make a plurality of access points share the same channel, thereby decreasing the interference in the network.

In the U.S. Pat. No. 8,031,664B2 allowed on Oct. 4, 2011, for which the applicants are Young Han Kim, Min Su Kang and Soongsil University Research Consortium and the title is “Channel management method and channel selection method for wireless node in wireless ad-hoc network”, a channel management method and a channel selection method for a wireless node are disclosed. In such methods, a channel selection of interference balancing is performed within an interference range, and the channel selection is based on a channel allocation probability.

However, it is also necessary to provide the technology of the high-speed data transmission by rationally allocating radio channels.

### SUMMARY OF THE INVENTION

According to an aspect of the present invention, a method for allocating a radio channel, includes the steps of determining one or more priority radio channels exclusively for transmitting priority data; determining whether there is a condition of allocating the one or more priority radio channels in an organized wireless group (OWG); and allocating one of the one or more priority radio channels, when the one or more priority radio channels are empty.

According to another aspect of the present invention, a system for allocating a radio channel, includes a first determination apparatus configured to determine one or more priority radio channels exclusively for transmitting priority data; a second determination apparatus configured to determine whether there is a condition of allocating the one or more priority radio channels in an organized wireless group (OWG); and an allocation apparatus configured to allocate one of the one or more priority radio channels, when the one or more priority radio channels are empty.

Thus, it is possible to allocate a priority radio channel temporarily to data with priority required for transmission or an organized wireless network. Accordingly, a high-speed transmission with low bit error rate can be performed more securely and efficiently, compared with the case where a common radio channel is allocated. Therefore, for example, important data or data in an organized wireless group (OWG) can be transmitted at a high speed.

### BRIEF DESCRIPTION OF THE DRAWINGS

FIG. 1 is a flowchart illustrating a method for allocating a radio channel according to an embodiment of the present invention;

FIG. 2A is a schematic drawing illustrating the structure of a radio communication network applying the channel allocation method according to the present invention;

FIG. 2B is a schematic drawing illustrating the channel allocation method according to an embodiment of the present invention;

FIG. 3A is a flowchart illustrating the generation and update of a co-channel interference table (CIT) in the channel allocation method according to an embodiment of the present invention;

FIG. 3B is a schematic drawing illustrating an example of the CIT;

FIG. 3C is a schematic drawing illustrating an example of a co-channel interference indication value (CIIV) performed by a normalization of 8-bit;

FIG. 4 is a flowchart illustrating a specific example of the channel allocation method;

FIG. 5 is a schematic drawing illustrating an example of the channel usage registration map (CURM);

FIG. 6 is a schematic drawing illustrating the rotation of an OWG among a waiting queue, a channel in pool A and a channel in pool B;

FIGS. 7A to 7C are schematic drawings illustrating three specific examples of setting different channel thresholds Vₜₕ;

FIG. 8 is a schematic drawing illustrating a dismiss process of an OWG; and

FIG. 9 is a block diagram illustrating a system for allocating a radio channel according to another embodiment of the present invention.

### DETAILED DESCRIPTION OF THE PREFERRED EMBODIMENTS

In the following, embodiments of the present invention are described in detail with reference to the accompanying drawings, so as to facilitate the understanding of the present invention. It should be understood that, the present invention is not limited to the embodiments, and the scope of the present invention may include various modifications, replacements or combinations. It should be noted that, the steps of the method described here may be implemented by any functional block or functional design, and the functional block or functional design may be implemented as a physical entity, a logical entity or a combination thereof.

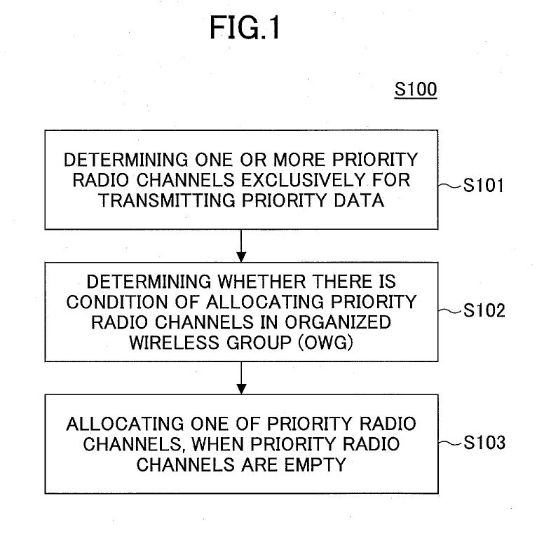

FIG. 1 is a flowchart illustrating a method for allocating a radio channel according to an embodiment of the present invention.

The radio channel allocation method 5100 illustrated in FIG. 1 includes the steps of determining one or more priority radio channels exclusively for transmitting priority data (S101); determining whether there is a condition of allocating the priority radio channel in an organized wireless group (OWG) (namely, an ad-hoc sub-network) (S102); and allocating one of the priority radio channels, when the one or more priority radio channels are empty (S103).

In an embodiment, the condition of allocating the priority radio channel includes at least one of the conditions that (1) there is priority transmission data to be transmitted between two radio mobile equipments, wherein the priority transmission data is transmitted by the allocated priority radio channel, (2) it is necessary to allocate the priority radio channel to a newly added OWG that does not have an allocated channel, (3) it is necessary to allocate the priority radio channel in an OWG, (4) an interference value of an existing mobile equipment or OWG is greater than a predetermined value, and (5) there is a request for the allocation of the priority radio channel from an OWG with an allocated channel. It should be noted that, the condition of allocating the priority radio channel is not limited to the above conditions. The interference value of the above OWG may be represented by at least one of a co-channel interference value, a spectrum utilization rate, a real-time packet loss rate, an average transmission delay and a radio transmission path loss.

In an embodiment, the step of determining the priority radio channels exclusively for transmitting priority data (S101) may include finding one or more radio channels with a utilization rate less than a first predetermined threshold from all of the available radio channels as the one or more priority radio channels.

In an embodiment, the utilization rate of the radio channel is determined from at least one of a spectrum utilization rate of the radio channel, a co-channel interference indication value of the radio channel, the number of access equipments of the radio channel, and an average packet loss rate of the radio channel. It should be noted that, the utilization rate of the radio channel may also be determined by other factors, as long as such factors can reflect the situation of occupation and interference of the radio channel.

In this way, all of the available radio channels may be divided, based on the situation of occupation and interference of the radio channel, into at least two types of channels: common channels that allow strong interference (A channels), and channels with weak interference or without an interference, that consist of priority radio channels exclusively for transmitting the priority data (B channels).

In an embodiment, the step of determining the priority radio channels exclusively for transmitting priority data (S101) may occur under one of the conditions that: a first predetermined time period has elapsed; it is necessary to transmit the priority transmission data; there is a newly added OWG; and interference of an OWG is greater than a predetermined value. That is to say, for example, the priority radio channels exclusively for transmitting the priority data may be redefined periodically (for example, once every three days or a week) based on the situation of occupation and interference (for example, the spectrum utilization rate of the radio channel) of each of the current radio channels. Thus, the priority radio channels exclusively for transmitting the priority data can always suit the current situation.

The data with priority required for transmission (the priority transmission data) may be, for example, a video, a picture or important data for sharing to be transmitted between two mobile equipments in a Wi-Fi network or an OWG, and usually, it is necessary to ensure transmitting the priority data more securely and efficiently than other common data. Therefore, it is necessary to allocate an exclusive channel to the priority data so as to perform a transmission securely at a high-speed.

In an embodiment, the method 100 may further include allocating the following channels other than the one or more priority radio channels to the priority transmission data when the one or more priority radio channels are not empty: (1) a radio channel with a minimum co-channel interference indication value, (2) one of the radio channels with a co-channel interference indication value less than a second predetermined threshold, (3) a radio channel with a minimum ratio of a co-channel interference indication value to a co-channel interference threshold, and (4) a radio channel with a minimum ratio of a co-channel interference indication value to a co-channel interference threshold, the ratio being less than 1. That is to say, if there is no available priority radio channel, the channel with a minimum co-channel interference indication value in the common radio channels other than the priority radio channels may be allocated to the priority transmission data. It should be noted that, in an embodiment of such step, the reason for setting the co-channel interference threshold is that, for example, a common channel with strong interference is not allocated to the priority data. If all of the co-channel interference values of the common channels are greater than the co-channel interference threshold, it means that all of the interferences of common channels are too strong. In this case, if a common channel with a strong interference is allocated to the priority data, the speed and quality of transmission of the priority data will be greatly reduced. Accordingly, the priority data may be put into a waiting queue to wait for the earliest priority radio channel which the transmission of the priority data completes, an empty priority radio channel or a common channel with a minimum co-channel interference indication value less than the co-channel interference threshold.

In an embodiment, the co-channel interference indication value may be obtained by calculating co-channel interference values of mobile equipments using a specific radio channel, and calculating a weighted average value of the calculated co-channel interference values by corresponding weighting factors to obtain the co-channel interference indication value of the specific radio channel. The co-channel interference values of mobile equipments are calculated by one or more of a real-time packet loss rate, an average transmission delay and a radio transmission path loss of mobile equipments using the same radio channel. It should be noted that, the co-channel interference indication value of a radio channel may also be calculated by other parameters, and the description thereof is omitted here since it is a known technology.

In an embodiment, the condition of allocating the priority radio channel includes at least one of the conditions that (1) there is priority transmission data between two radio mobile equipments, the priority transmission data being transmitted by the allocated priority radio channel, (2) it is necessary to allocate the priority radio channel to a newly added OWG, (3) it is necessary to allocate the priority radio channel in an OWG, (4) an interference value of an existing mobile equipment or OWG is greater than a predetermined value, (5) there is a request for the allocation of the priority radio channel from an OWG with an allocated channel, and (6) there is an OWG that is waiting for the allocation of the priority radio channel in a waiting queue.

In an embodiment, the allocation of the priority radio channel may be terminated when one of the following situations occurs: (1) a predetermined time period has elapsed; (2) the transmission of priority data is completed; and (3) a request for terminating the allocation of the priority radio channel has been received. In an embodiment, the priority radio channel may be allocated to only one transmission of the priority data every time, that is to say, only one transmission of the priority data may be performed by the priority radio channel every time. In this way, the effect of the bandwidth occupation and the transmission interference of other data on the transmission of the priority data can be reduced, therefore, a transmission with low bit error rate can be performed more securely and efficiently and the priority data can be transmitted at a high speed. It should be noted that, the number of the priority data which the priority radio channel transmits may also be determined, or a threshold of a utilization rate of the priority radio channel (such as a threshold of a spectrum utilization rate, a threshold of the co-channel interference value, etc.) may be determined, so as to transmit as much priority data with the range of the threshold of the utilization rate by the priority radio channel.

In an embodiment, the priority transmission data may be transmitted between the mobile equipments in the OWG. In an embodiment, all of the mobile equipments in an OWG may perform a communication with each other by one of the allocated priority radio channels, after the one or more priority radio channels are allocated to the OWG. It should be noted that, in the present embodiment, the OWG may be a network that is organized by the users themselves and includes a number of the mobile equipments. In such network, a mobile equipment (as a master node) may manage other mobile equipments (as slave nodes), for example, the entering of the node to the OWG, the leaving of the node from the OWG, the authentication of the slave node, a request of channel allocation to a radio access equipment, the channel allocation to nodes, the collection of the co-channel interference values of the mobile equipments in the OWG, the sending of the co-channel interference values, etc. Accordingly, the mobile equipments in such OWG are different from sparse mobile equipments in a Wi-Fi environment. It should be noted that, in an embodiment, the priority transmission data is not the data transmitted between any two mobile equipments in a common Wi-Fi network, but the data transmitted between two (or more) mobile equipments in such OWG. Additionally, in another embodiment, all of the mobile equipments in an OWG may perform a communication with each other by one of the allocated priority radio channels, after the one or more priority radio channels are allocated to the OWG; that is to say, in such embodiment, when a priority radio channel has been allocated to the OWG (for example, by a request for allocating a radio channel from a master node in the OWG), all of the mobile equipments in the OWG can transmit the data securely and efficiently with a low bit error rate by using the allocated priority radio channel. In this way, the allocation of the priority radio channel can be applied to the OWG creatively, and a new allocation method of the priority radio channel in OWG can be provided.

In an embodiment, the OWG may include a region limited network. Authenticated mobile equipments in the region limited network can communicate with each other, and the authenticated mobile equipments in the region limited network cannot communicate with unauthenticated mobile equipments or another mobile equipment on the outside of the region limited network. The region limited network may also represent a region where the range can be uniquely determined by a physically controlling method or an arbitrarily adjustment. Similarly to a P2P network with a plurality of mobile equipment nodes, the authenticated mobile equipments in the region limited network can communicate with each other, and the authenticated mobile equipments in the region limited network cannot communicate with the unauthenticated mobile equipments or another mobile equipment on the outside of the region limited network. As an example, the limited region includes a region uniquely determined by a range of infrared rays emitted by one or more light emitters (the lights emitted by the light emitters have a good directivity, and preferably, are the lights of light emitting diodes (LEDs)), a region uniquely determined by a range of microwaves emitted by one or more microwave emitters, a limited region of the near field communication (NFC) technology and a limited region covered by other signals, but is not limited thereto. For example, a detailed description of the self-organized P2P network of a limited region may be referred to in the pending Chinese Application No. 201310056656.0 filed on Feb. 22, 2013 and the pending Chinese Application No. 201310176417.9 filed on May 14, 2013 for which the inventors are the same as the present application, and the entire contents of which are hereby incorporated by reference. In these documents, the “organized wireless group” is used as the name of an organized network; similarly, in the present application, the “organized wireless group” is used as an example of the organized network and is not limited thereto.

Thus, it is possible to allocate a priority radio channel temporarily to data with priority required for transmission or an organized wireless network. Accordingly, a high-speed transmission with low bit error rate can be performed more securely and efficiently, compared with the case where a common radio channel is allocated. Therefore, for example, important data or data in an organized wireless group (OWG) can be transmitted at a high speed.

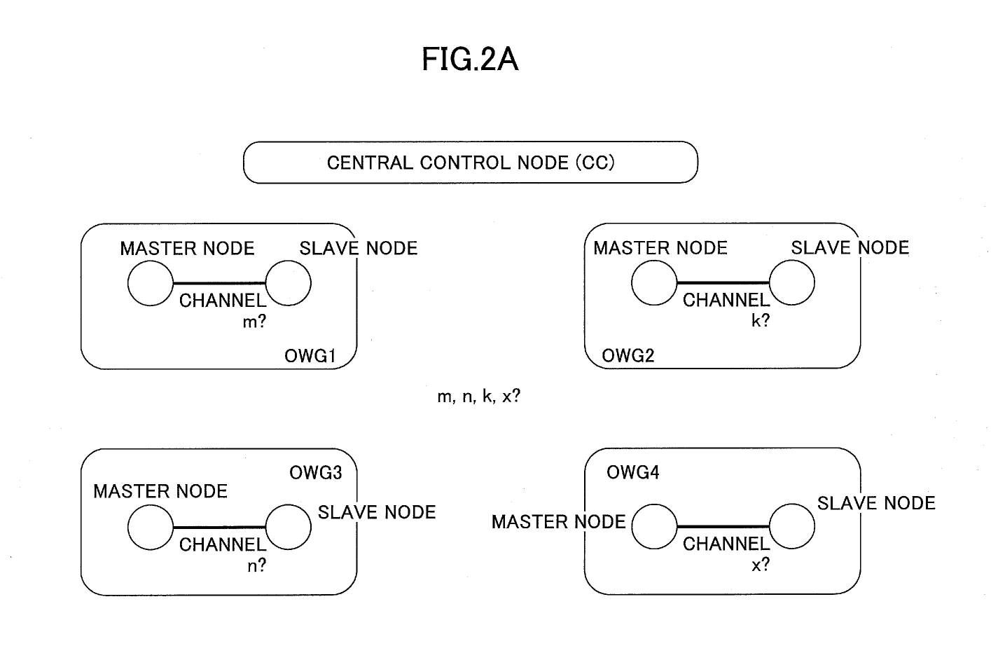

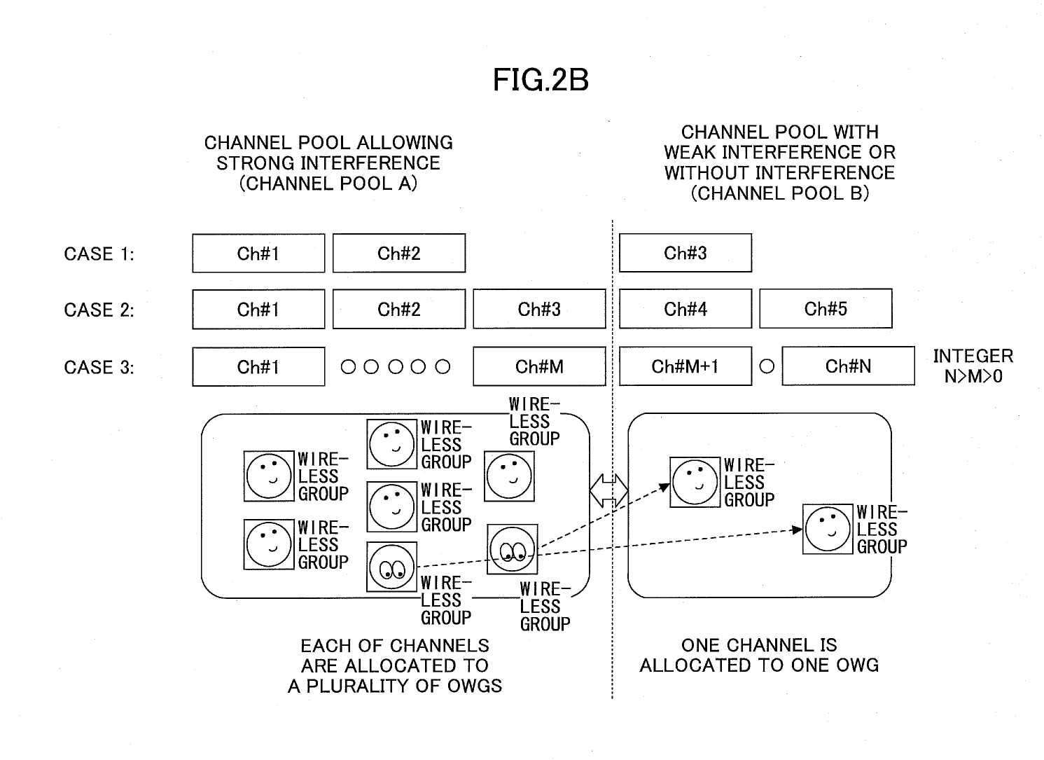

In the following, a detailed example of the channel allocation method according to the present invention will be described with reference to FIG. 2A.

FIG. 2A is a schematic drawing illustrating the structure of a radio communication network applying the channel allocation method according to the present invention.

In FIG. 2A, there are four organized wireless groups (OWGs) 1-4 and one central control node (CC). Each of OWGs may be a P2P (Peer-to-Peer) sub-network based on Wi-Fi-Direct, and may also be a Ad-hoc sub-network cluster or a region limited network. Usually, each of OWGs includes one master node, and 0 or a plurality of slave nodes.

In each of OWGs, usually, the master node maintains the sub-network session and the connection between nodes in the OWG; when a slave node of the OWG leaves from the OWG, the master node deletes all of the connection information of the slave node in the OWG and notifies other slave nodes in the same OWG; when the master node leaves, a new master node is generated from the slave nodes, and the leaving master node transfers all of the information and functions of the master node to the new master node. In this embodiment, operation channels for connecting nodes in OWG may be allocated by the central control node in a unified manner. Since the number of available non-overlapping channels in the Wi-Fi system is finite, if there are a lot of OWGs in a open operation space, a plurality of OWGs may share a channel. Therefore, the aspect of the present invention is to provide a method for avoiding co-channel interference, utilizing the channels efficiently and transmitting the data securely and efficiently.

FIG. 2B is a schematic drawing illustrating the channel allocation method according to an embodiment of the present invention.

As illustrated in FIG. 2B, the process of allocating the channel includes determining one or more priority radio channels (B channels in FIG. 2B) exclusively for transmitting priority data; determining whether there is a condition of allocating the priority radio channel (for example, when an OWG is newly added) in an organized wireless group (OWG); and allocating one of the priority radio channels, when the one or more priority radio channels are empty.

1. priority channel determination step: determining which channel(s) is a priority channel. Specifically, all of the available channels may be divided into two types of channels. One type of channels are defined as A channels (common channels), where strong co-channel interference may exist and plural OWGs may share the channel and obtain the channel by a competition mechanism. The other one type of channels are defined as B channels (priority channels) that usually is a channel with weak interference or without interference, and is especially reserved for a temporary demand of high-speed data or an OWG with great interference. It should be noted that, in this embodiment, a channel may be allocated to the whole OWG rather than a single mobile equipment. By allocating a channel to the whole OWG, all mobile equipments in the OWG can transmit data in the allocated channel. However, the present invention is not limited to this, and may also be allocated to a single mobile equipment (for example, there is only one mobile equipment in the OWG) and/or a portion of mobile equipments in the OWG, and/or be allocated for the communication between a portion of the mobile equipments in the OWG and a portion of the mobile equipments on the outside of the OWG.

In the following, an example of division criterion will be described.

As described above, all of the available channels in the system may be divided into two types of channels, A channels and B channels, before the channel allocation. Usually, the two types of channels meet the following conditions (the conditions are just examples and the present invention is not limited to these conditions):

1. supposing that the number of channels in the system is N (a positive integer).

2. the channel feature of B channels is no interference or having low environment interference, and the channel feature of A channels is allowing strong environment interference.

3. one or more radio channels with a utilization rate less than a first predetermined threshold may be extracted from the B channels without interference or with low environment interference, as one or more priority radio channels.

4. the utilization rate of the radio channel is determined based on at least one of: the spectrum utilization rate of the radio channel, the co-channel interference indication value, the number of access equipments of the radio channel, and the average packet loss rate of the radio channel.

5. the total number of the A channels is M (a positive integer less than N), and other channels (N-M) may belong B channels.

6. usually, the number of A channels is greater than B channels (the present invention is not limited to this, and the reason is to avoid that the number of B channels is too much and the A channels are too congested).

The step of determining the priority radio channels exclusively for transmitting priority data occurs under one of the conditions that: (1) a first predetermined time period has elapsed; (2) it is necessary to transmit the priority transmission data; (3) there is a newly added OWG; and (4) interference of an OWG is greater than a predetermined value. That is to say, for example, the priority radio channels exclusively for transmitting the priority data may be redefined periodically (for example, once every three days or a week) or momentarily (for example, when the priority transmission data is transmitted, or when a new equipment or an OWG is joined) based on the situation of occupation and interference (for example, the (spectrum) utilization rate of the radio channel) of each of the current radio channels. Thus, the priority radio channels exclusively for transmitting the priority data can always suit the current situation.

FIG. 2B illustrates three cases (case 1, case 2 and case 3) of the channel allocation.

Usually, there are three operation channels, the first channel (2412 MHz), the sixth channel (2437 MHz), and the eleventh channel (2462 MHz) in a Wi-Fi environment, and these channels will be described as an example.

FIG. 2B illustrates the divided A channel pool and B channel pool, and the channel allocation and the rotation (switching) of OWGs in three cases (case 1: there are three available channels; case 2: there are five available channels; case 3: there are N available channels).

In the case 1, usually, there are three available channels (commonly used channel 1-2412 MHz, channel 2-2437 MHz and channel 3-2462 MHz) in a Wi-Fi 2.4 GHz operation environment, and the channels 1 and 2 are located in A channel pool, and the channel 3 is located in B channel pool. In case 2, there are five available channels, and three channels are located in A channel pool and the other two channels are located in B channel pool. In case 3, there are N available channels, and M available channels are located in A channel pool and (N-M) available channels are located in B channel pool.

Usually, when an OWG is formed as a network by a master node, the master node may apply for available channels to the central control node. There may be many OWGs in a stable system, and some OWGs work in the same channel. In A channels, when an OWG has strong co-channel interference, the central control node may switch the OWG to a B channel so as to improve communication efficiency. In specific conditions, an OWG operated in B channel may also be switched back an A channel with strong interference. This dynamic rotation (switching) will be described in the following.

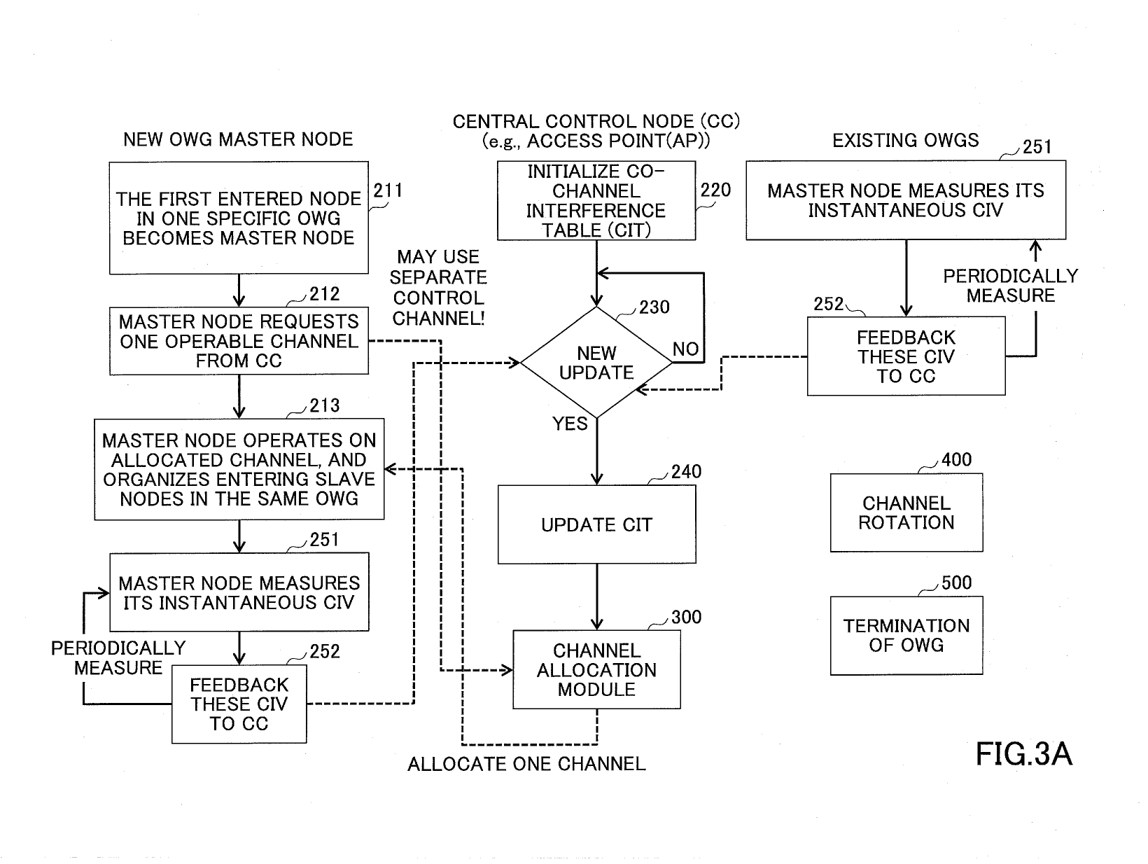

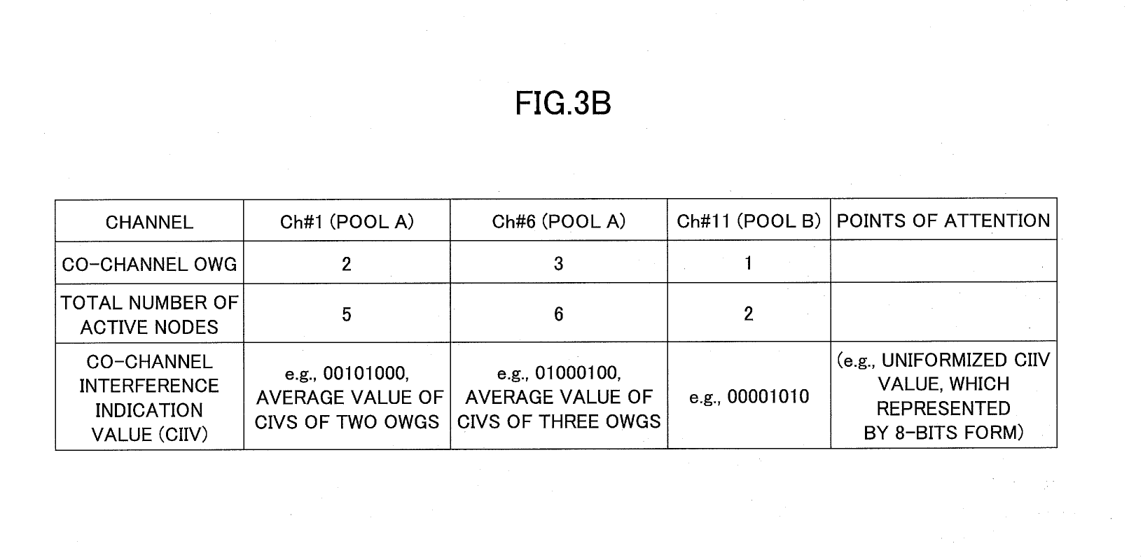

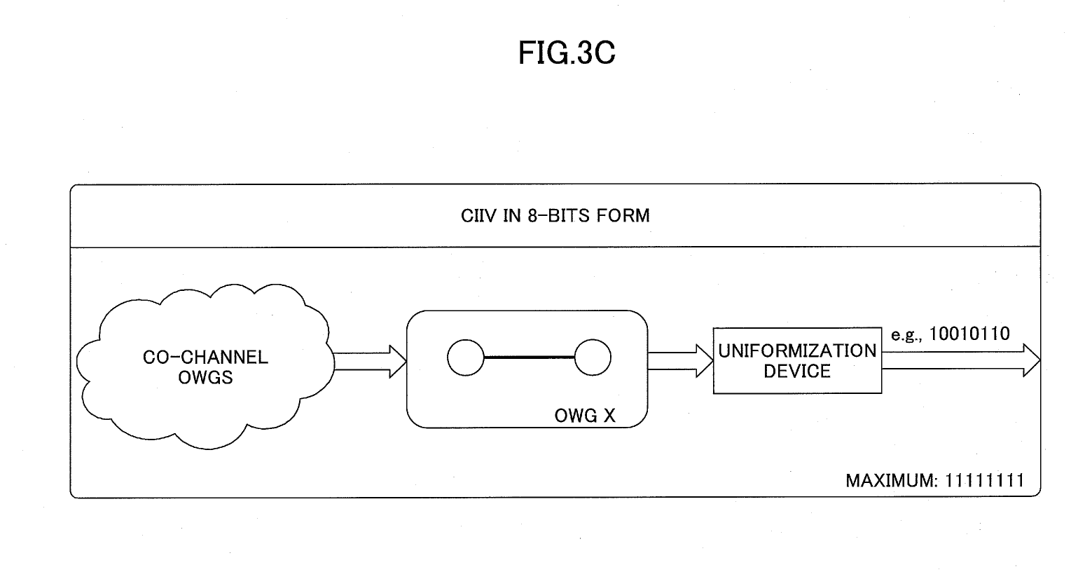

FIG. 3A is a flowchart illustrating the generation and update of a co-channel interference table (CIT) in the channel allocation method according to an embodiment of the present invention.

After determining the classification of the channels (determining which channels are priority channels), it may be determined whether there is a condition of allocating the priority radio channel.

The condition of allocating the priority radio channel includes at least one of the conditions that: (1) it is necessary to allocate the priority radio channel to a newly added OWG (it is necessary to transmit data with priority required for transmission between mobile equipments in the new OWG), (2) there is priority transmission data between two radio mobile equipments (regardless of whether they are located in the same OWG or not, or they are mobile equipments in the OWG or single mobile equipments), (3) it is necessary to allocate the priority radio channel in an OWG, (4) an interference value of an existing mobile equipment or OWG is greater than a predetermined value, (5) there is a request for the allocation of the priority radio channel from an OWG with an allocated channel, etc.

Next, a corresponding channel allocation may be performed based on the situations.

First, one of the priority radio channels may be allocated, when the one or more priority radio channels are empty. As described above, after all of the available channels are divided into A common channels and B priority channels, it is checked whether there is an empty B channel in B channels, and if it is yes then the empty B channel is allocated for the transmission of the priority transmission data. The step of determining whether a B channel is empty is performed by determining (1) whether there is data transmitted in the channel or not, and (2) the utilization rate of the channel is very small or not (for example, it is less than a predetermined threshold that is obtained by scanning from the spectrum or the experience of observing). The utilization rate of the radio channel may be determined from at least one of a spectrum utilization rate of the radio channel, a co-channel interference indication value of the radio channel, the number of access equipments of the radio channel, an average packet loss rate of the radio channel, etc.

On the other hand, when all of the one or more priority radio channels (B channels) are not empty, the following common channels (A channels) other than the one or more priority radio channels (B channels) may be allocated to the priority transmission data: (1) a common radio channel with a minimum co-channel interference indication value, (2) one of the common radio channels with a co-channel interference indication value less than a second predetermined threshold, and (3) a common radio channel with a minimum co-channel interference indication value that is less than a co-channel interference threshold. In the following, the example of the calculation method of the co-channel interference indication value will be described.

Specifically, as illustrated on the right side of FIG. 3A, when a radio communication system is operating, usually, there are many OWGs. First, for an existing OWG in the operating radio communication system, its master node may periodically detect a real-time co-channel interference value (CIV) (the CIV will be described in the following) (step 251) and feedback the obtained CIV to the central control node (step 252) to update a co-channel interference table (CIT) (an example of CIT may be referred to in FIG. 3B). On the other hand, when a new OWG is initialized for being operated in the system, the first node is set as the master node (step 211) and requests one operable channel from the central control node (step 212). After the channel is allocated, the master node operates on the allocated channel and receives an adding request from the slave node (step 213). It should be noted that, currently, only in a network with the property of limited region (region limited network), a slave node can uniquely distinguish the master node in the same region and be added in a sub-network system that is maintained by the master node. Then, similarly, a newly added master node in the OWG may periodically detect the real-time co-channel interference value (CIV) (step 251), and feedback the obtained the CIV to the central control node (step 252) so as to update the co-channel interference table.

In the radio communication environment, regardless of whether a mobile equipment is located in the OWG, each of the mobile equipments may receive co-channel interference from other mobile equipments or other access point (AP) equipments sharing the same channel. Therefore, it is supposed that each of mobile equipment nodes has a co-channel interference estimation component for estimating the co-channel interference value (CIV).

In this case, the co-channel interference value of a mobile equipment may be calculated by the following method:

CIV=fun(real-time packet loss rate, average transmission delay, radio transmission path loss and other possible measures)

where, fun(*) represents the function of *. That is to say, the CIV may be calculated from a real-time packet loss rate, an average transmission delay, a radio transmission path loss or other possible measures.

It should be noted that, for the calculation of the CIV of the whole OWG, an average value of CIVs of all mobile equipments in the OWG may be calculated directly as the CIV of the OWG. Alternatively, a weighting factor (for example, greater than 1) may be set for some mobile equipments (for example, which the communication is protected), and a weighted average value of the estimated CIVs of mobile equipments in the OWG may be calculated by the weighting factors to obtain the CIV of the OWG. For the OWGs or other single mobile equipments sharing the same channel, an average value (or a weighted average value) of all CIVs of these OWGs or other single mobile equipments may also be calculated, so as to obtain a co-channel interference indication value (CIIV) for representing the shared channel and reflect the interference situation of the channel. The CIIV of the channel may also be multiplied by another weighting factor (less than 1 or greater than 1) to increase or decrease the probability of allocating the channel. For example, supposing that the channel is shared by mobile equipment 100-1 (not shown), mobile equipment 100-2 (not shown), OWG 101 (not shown), OWG 102 (not shown) and OWG 103 (not shown), and the estimated CIVs are 50, 50, 100, 100 and 200, respectively; the co-channel interference indication value of channel 1 CIIV₁ may be obtained by calculating the average value of the estimated CIV of the mobile equipments or OWGs sharing the same channel 1 (in this example, the calculated CIIV₁ of channel 1 is CIIV₁=(50+50+100+100+200)/5=100).

It should be noted that, the CIT stored in the central control node does not include CIVs of mobile equipments or single mobile equipments in the OWG, but CIIVs of available channels. An example of the CIT is illustrated in FIG. 3B in detail.

In FIG. 3A, the central control node initializes the CIT (step 220). When a real-time CIV reported from an OWG in the system is received, it is necessary to update CIT accordingly (by re-calculating the CIIV of the allocated channel to the OWG) (steps 230 and 240). When a newly operating OWG requests an operable channel to the central control node, the central control node performs the channel allocation by a certain algorithm (step 300). The allocation algorithm will be further described later.

All of OWGs receive the interference from another OWG sharing the channel. Therefore, it is necessary to define the size of the co-channel interference in all of the channels in the system. As a possible example, as illustrated in CIT of FIG. 3B, all of the channels in the system and its classes (A channels or B channels, and its resonant frequencies), and the number of OWGs and the number of operating nodes (the number of mobile equipments) are illustrated. As illustrated in FIG. 3C, the size of the real-time measured co-channel interference of a channel is represented by the CIIV (in an embodiment, an 8-bits normalization is performed for the CIIV, and a corresponding 8-bits value is obtained (for example, between 00000000₂ and 11111111₂ (where, the subscript 2 represents a binary value), so as to perform a bit transmission of the radio communication)).

There are many detection methods of the CIIV, the CIIV may be calculated by different parameters, and the CIIV mainly represents the co-channel interference that is detected in real time in the environment. The average value of the co-channel interference values of mobile equipments and OWGs sharing the same channel are recorded in the CIT. The calculation method of the CIIV may also refer to the U.S. Patent Application US20120182896A1 published on Jul. 19, 2012, for which the title is “INTERFERENCE MEASUREMENT METHOD AND APPARATUS FOR USER EQUIPMENT HAVING MULTIPLE HETEROGENEOUS COMMUNICATION MODULES IN WIRELESS COMMUNICATION SYSTEM”.

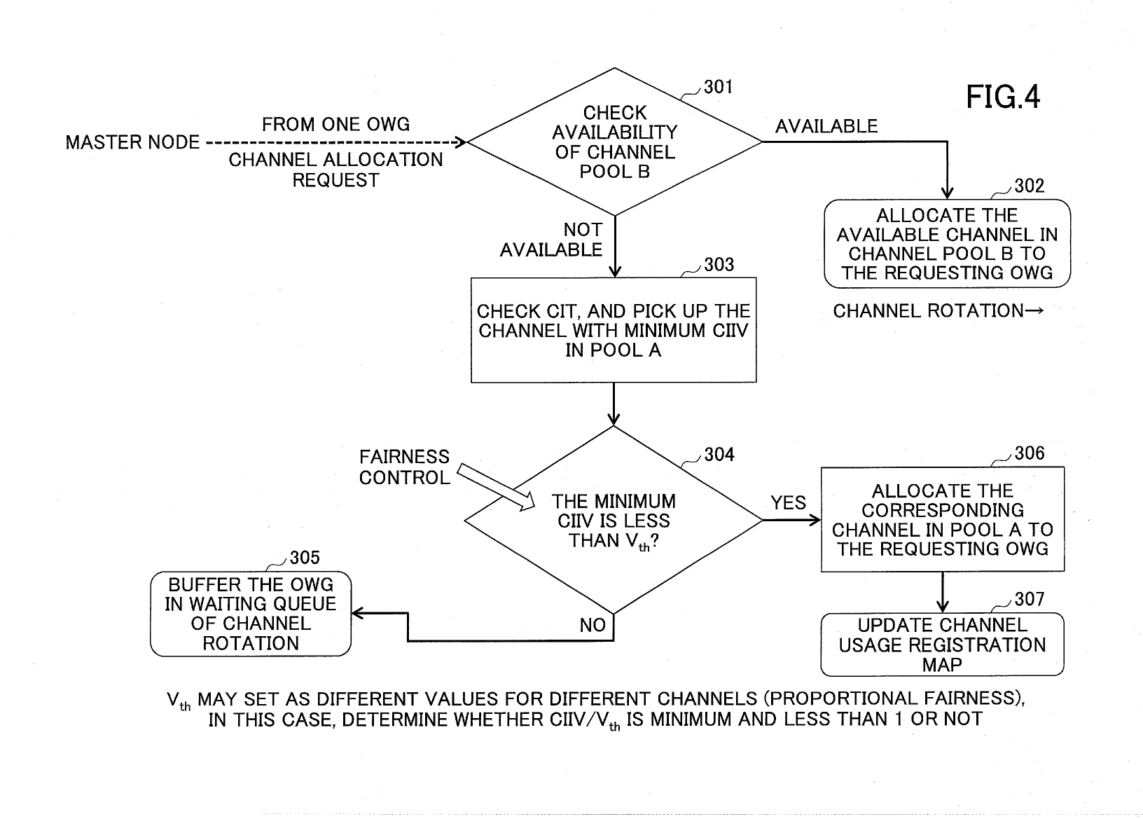

In the following, a specific flow of the channel allocation method will be described with reference to FIG. 4.

Specifically, when a central control node receives a channel allocation request from a master node of a OWG, the central control node checks the availability of B channels (there is a B channel that is not occupied) (step 301), if it is yes then the B channel is allocated to the requesting OWG. Otherwise, the channel with minimum interference is determined from the A channels (step 303). Specifically, the CIIVs of the A channels are compared to a predetermined channel interference threshold Vₜₕ (step 304) (it should be noted that, if a fairness control is applied, for example, in step 303, the A channel with a minimum CIIV/Vₜₕ may be selected to the requesting OWG (step 306), and in step 304, a comparison whether it is less than 1 or not is performed), if the CIIV is less than the threshold (CIIV/Vₜₕ<1), the A channel with the minimum CIIV/Vₜₕ less than 1 is allocated to the OWG, and if the CIIV is greater than or equal to the threshold (CIIV/Vₜₕ≧1) (namely, there is no A channel to be allocated), the OWG to be allocated a channel is put into a channel allocation waiting queue (or called “waiting queue”) (step 305).

It should be noted that, the predetermined channel interference threshold Vₜₕ of the A channels may be the same value for all of the A channels, and the predetermined channel interference thresholds Vₜₕ may also be set based on different A channels, respectively. Therefore, when calculating the CIIV/Vₜₕ value of a specific A channel, the CIIV of the A channel and the specific Vₜₕ of the A channel may be considered. Accordingly, the allocation ratios of different A channels (the number or probability of allocation to the OWG) can be adjusted by setting Vₜₕ of different A channels.

Namely, when the one or more priority radio channels are not empty (or unavailable), the following channels other than the one or more priority radio channels may be allocated to the priority transmission data: (1) a common radio channel with a minimum co-channel interference indication value, (2) one of the common radio channels with a co-channel interference indication value less than a second predetermined threshold, (3) a radio channel with a minimum ratio of a co-channel interference indication value to a co-channel interference threshold, and (4) a radio channel with a minimum ratio of a co-channel interference indication value to a co-channel interference threshold, the ratio being less than 1. It should be noted that, in this embodiment, preferably, when the one or more priority radio channels are not empty, a common radio channel with a minimum ratio of a co-channel interference indication value to a co-channel interference threshold, or a radio channel with a minimum ratio of a co-channel interference indication value to a co-channel interference threshold, the ratio being less than 1 (namely, an A channel with a minimum CIIV which CIIV/Vₜₕ<1), may be allocated to the priority transmission data.

In this example, the selection of a common radio channel mainly considers the co-channel interference indication value and the co-channel interference threshold; however, the present invention is not limited to this, and may also consider other factors of the utilization of common radio channels to determine whether to allocate and which common radio channel is to be allocated.

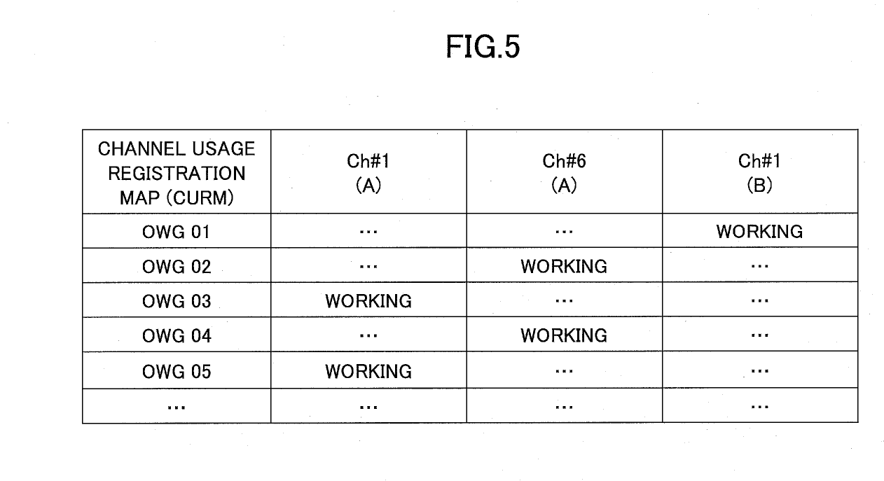

For example, when the operation channel of a OWG changes, the central control node may also update a channel usage registration map (CURM) illustrated in FIG. 5 in real time. The current operating OWGs and channels are recorded in the CURM in detail, and the CURM is dynamically updated in accordance with an adding of a new OWG, a dismiss of an (active) OWG with a channel, or a channel allocation and rotation.

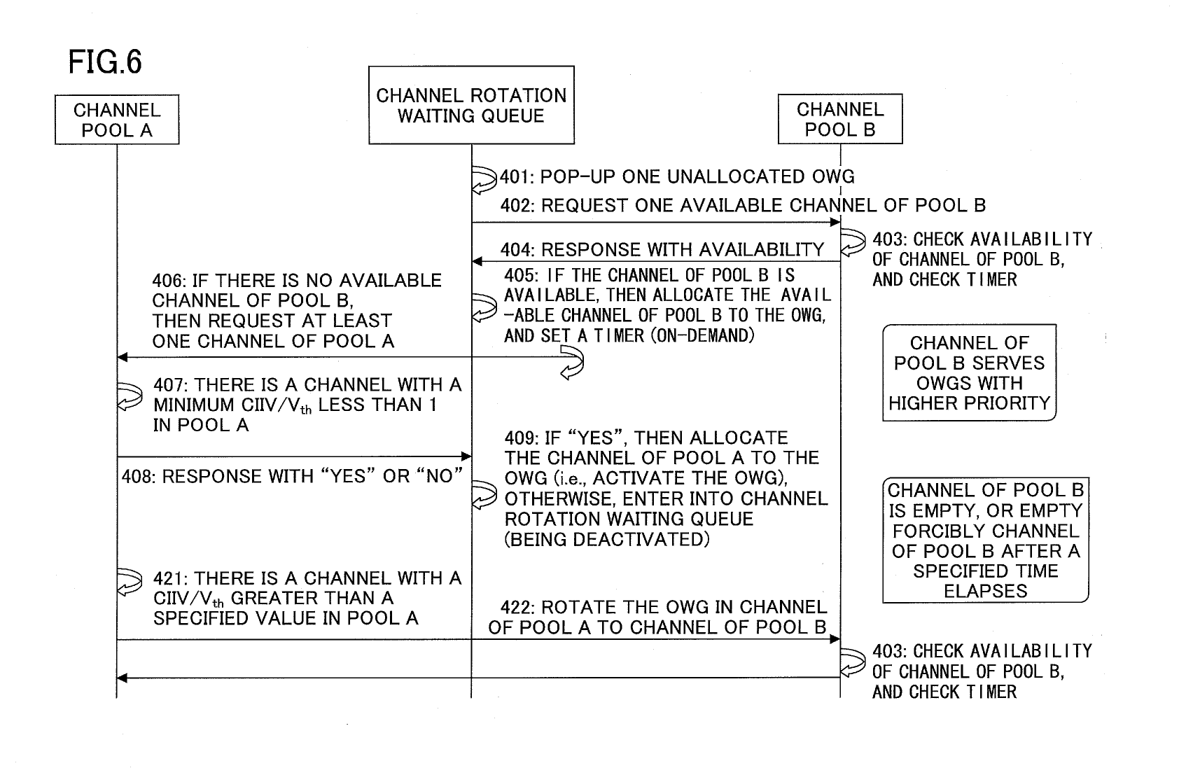

FIG. 6 is a schematic drawing illustrating the rotation of an OWG among a waiting queue, a channel in pool A and a channel in pool B.

When operating in actuality, all of the OWGs operating in an A channel (or the OWGs waiting the channel allocation in a waiting queue) may be rotated (switched) to a B channel under a certain condition, so as to obtain a higher channel utilization rate. Similarly, the OWGs in a B channel terminates the occupation of the B channel under a certain condition (large data such as a video, or transmission finishing), and is rotated to an A channel. Such a dynamic rotation process between an A channel and a B channel is as follows.

step 401: pop-up one unallocated OWG;

step 402: the OWG request one available B channel;

step 403: check the availability of the B channel, and (optionally) check a timer;

step 404: response with the availability; step 405: if the B channel is available, then allocate the available B channel to the OWG, and set a timer (on-demand);

step 406: if there is no available B channel, then request at least one A channel;

step 407: there is an A channel with a minimum CIIV/vₜₕ less than 1 or not;

step 408: response with “YES” or “NO”; step 409: if “YES”, then allocate the A channel to the OWG (namely, activate the OWG), otherwise, enter into channel rotation waiting queue (being deactivated);

step 421: monitor whether there is an A channel with CIIV/Vₜₕ greater than a specified value (representing that the interference of the A channel is too large);

step 422: if yes, then rotate the OWG in the A channel to a B channel;

and repeat steps 403-409.

The central control node may monitor the A channel, the B channel and the channel allocation waiting queue consistently as follows.

(I) monitor whether there is an available channel in the channel pool B. It is usually triggered by a time-out or an event. For example, an OWG operating in a B channel may be triggered to be allocated an A channel by a maximum allowable operation time (it may be triggered to be rotated to the A channel when time-out occurs), an exchange finishing of large data in the OWG itself or a received message for determining the allocation of the B channel, so that the OWG operates in a channel with strong interference to maintain an OWG inside connection and a small data interaction. When the OWG cannot be rotated to an A channel, the OWG enters the channel allocation waiting queue.

(II) monitor whether there is an OWG waiting for a start-up in the channel allocation waiting queue or not. When there is a waiting OWG in the channel allocation waiting queue, the first OWG in the queue prepares for the channel allocation. If an appropriate B channel is detected in (I), the B channel is allocated to the OWG. Otherwise, the process proceeds to the next step.

(III) monitor whether there is a channel with a CIIV less than Vₜₕ and a minimum CIIV/Vₜₕ (namely, a minimum CIIV) in the A channels, if yes, then rotate the first OWG in the channel allocation waiting queue of (II) to the A channel. Otherwise, maintain the standby state and proceed to the next step.

(IV) (when the channel allocation waiting queue is empty) monitor whether there is a request of an OWG operating in a channel of the channel pool A for rotating to a B channel (for example, there is large data or important data to be transmitted) or not, if yes, then allocate an available B channel in (I) to the OWG. It should be noted that, the priority of the OWGs in the channel allocation waiting queue may be higher than the OWGs in the A channels requesting for rotating to the B channels. Therefore, preferably, when the B channels are empty, the empty B channels may be allocated to the OWGs waiting in the channel allocation waiting queue as priority; and only if the channel allocation waiting queue is empty, the OWGs in the A channels are rotated to the B channels. Of course, this is just a preferred example, and the present invention is not limited to this example.

(V) when the data transmission of an OWG operating in the B channels has been completed, or the occupation of the channel has timed out, or an OWG requests to terminate the allocation of a B channel, the OWG may be rotated to an A channel with smallest interference (as the criteria, the channel interference threshold Vₜₕ of the A channel is similar to (III), and the CIIV/Vₜₕ value may be the minimum value (namely, the CIIV is the minimum value)). Alternatively, when there is no appropriate A channel or available A channel, the OWG may enter the channel allocation waiting queue.

The rotation (switching) and allocation of an OWG among the waiting queue, A channels and B channels are described above, however such description is just an example and the present invention is not limited to this example.

As described above, the Vₜₕ value is a system design parameter and may be set flexibility to control the fairness of the channel utilization. In the following, the control of the fairness of the channel utilization based on the Vₜₕ value will be described.

In the following, some examples of setting different channels to achieve different purposes of the system operation will be described.

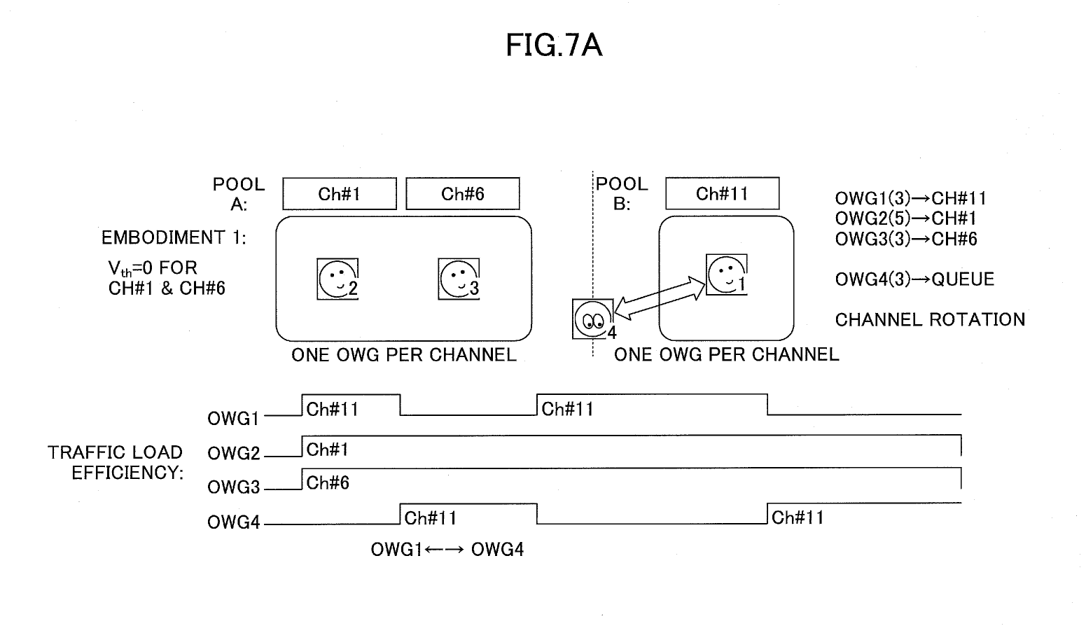

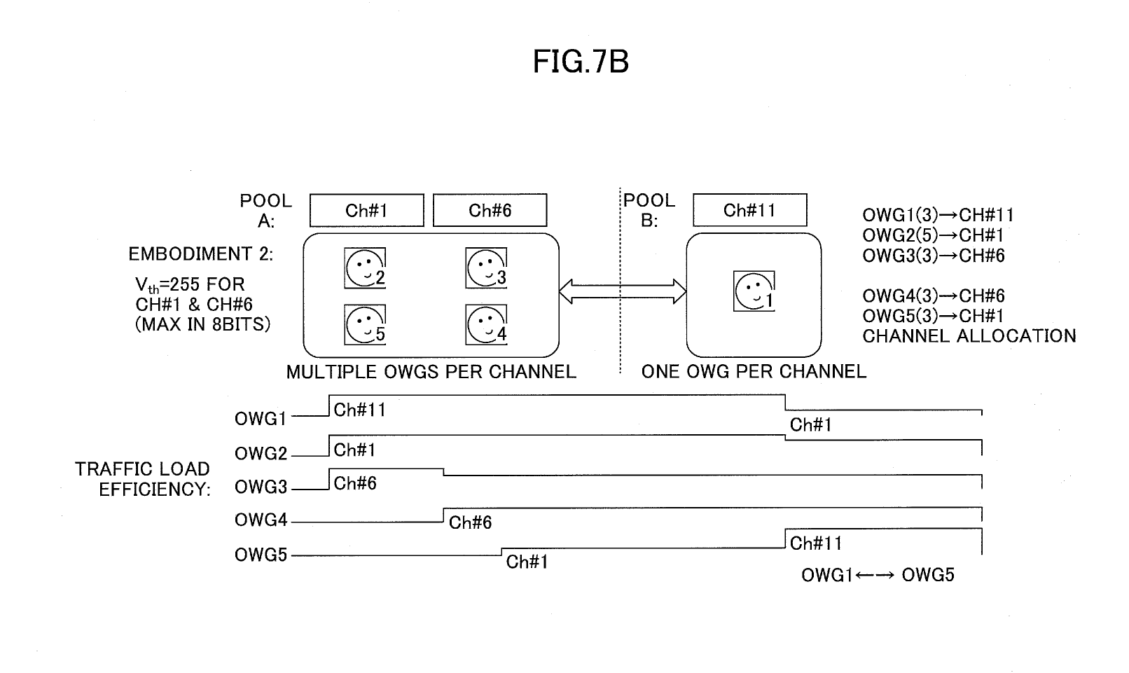

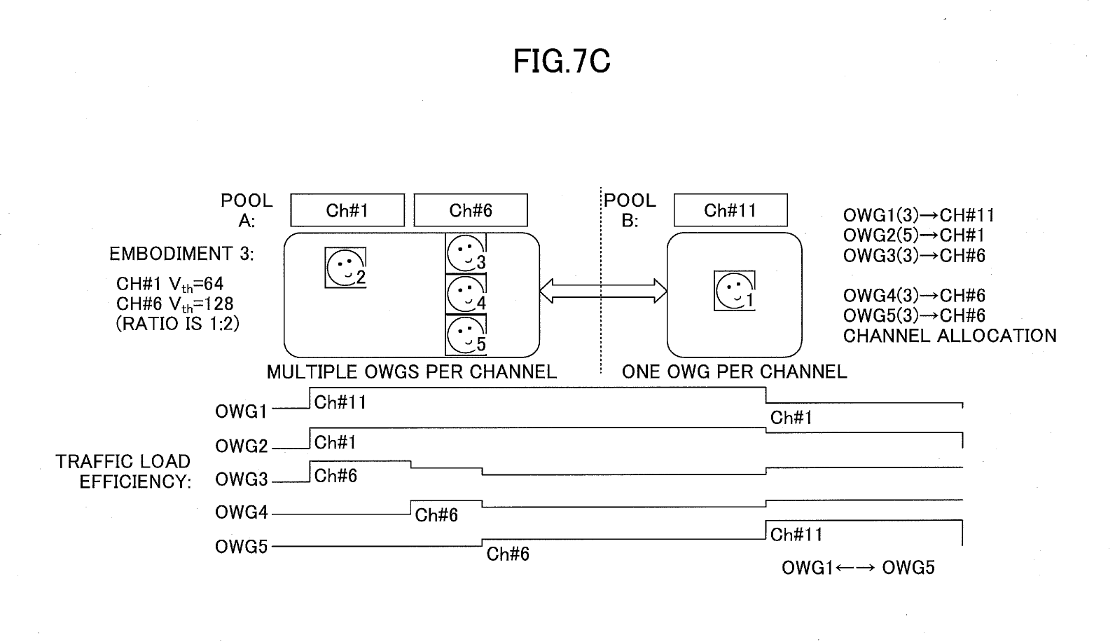

FIGS. 7A to 7C are schematic drawings illustrating three specific examples of setting different channel thresholds Vₜₕ.

First, assume that the used channels are channels commonly used in the Wi-Fi: the first channel (2412 MHz), the sixth channel (2437 MHz) and the eleventh channel (2462 MHz). Also, assume that the channel pool A includes the first channel and the sixth channel, and the channel pool B includes the eleventh channel. The threshold Vₜₕ of A channels may be set as a small value, and typically, the thresholds of channel 1 and 6 are set as 0.

The traffic load efficiency of the radio network (for example, that may be represented by the spectrum utilization rate, co-channel interference indication value, etc.) is illustrated in FIG. 7A. Four OWGs, namely OWG1, OWG2, OWG3 and OWG4 are added one by one. In this example, when OWG1 (for example, including 3 nodes, each of the OWGs having one master node, and 0 or plural slave nodes) is added, OWG 1 is allocated in the eleventh channel; when OWG2 (5 nodes) is added, OWG2 is allocated in the first channel; and when OWG3 (3 nodes) is added, OWG 3 is allocated in the sixth channel. Subsequently, when OWG4 (3 nodes) is joined, after the central control node checks the interference of all channels, it is determined that all of the thresholds are exceeded (the thresholds are 0, and if a node is operating then the channel interference will be greater than 0). Accordingly, OWG4 enter the waiting queue. OWG4 may be rotated to channel 11 at a certain time, and OWG 1 may be rotated to the waiting queue. As illustrated by the rotation point “OWG1<->OWG4” in FIG. 7A, when the channels of two OWGs are exchanged each other, the traffic load efficiency also changes accordingly.

In FIG. 7B, similarly, supposing that the channel pool A includes the first channel and the sixth channel, and the channel pool B includes the eleventh channel. In this example, the thresholds Vₜₕ of A channels may be set as a large value, and typically, in an example of 8-bits, the thresholds of channels 1 and 6 may be set as the maximum value 255.

Five OWGs, namely OWG1, OWG2, OWG3, OWG4 and OWG5 are added one by one. The adding processes of OWGs 1 to 3 are similar to the previous example. When OWG4 is joined, it is determined that the current channel with the minimum interference less than the threshold is the sixth channel, and OWG4 is allocated in the sixth channel. Similarly, OWG 5 is allocated in the first channel. A subsequent channel rotation process occurs between an A channel and a B channel, unless a channel reaches a maximum value of the strong interference (it does not occur in the normal setting).

Additionally, two points should be noted.

1. when the channel threshold is large enough, if a newly added OWG is allocated in a channel that has been allocated to an operating OWG, the traffic load efficiency of the radio network of the original operating OWG will reduced due to a co-channel competition. As illustrated in FIG. 7B, when OWG4 is allocated to the sixth channel, the efficiency of OWG3 that has been originally allocated to the sixth channel is reduced because of its influence.

2. the channel rotation in cases where the channel threshold is set as 255 usually occurs between an OWG operating in an A channel and an OWG operating in a B channel. As illustrated in FIG. 7B, at a certain time, a channel rotation is performed for OWG1 and 0WG5.

In the example of FIG. 7C, the thresholds Vₜₕ of A channels may also be set based on the ratio. In an example of 8-bits, typically, the thresholds of channels 1 and 6 are set as 64 and 128, namely, the ratio is 1:2. It should be noted that, the setting based on the ratio is just an example, and the thresholds of channels. 1 and 6 may be set as any values.

As illustrated in FIG. 7C, five OWGs, namely OWG1, OWG2, OWG3, OWG4 and OWG5 are added one by one. The adding processes of OWG1 to OWG3 are similar to the above example. When OWG4 is started, it is determined that the current channel with minimum interference less than the threshold is the sixth channel, and OWG4 is allocated in the sixth channel since the sixth channel currently has a minimum CIIV/Vₜₕ. Similarly, when OWG 5 enters, OWG5 is also allocated in the sixth channel, because the sixth channel still has a minimum CIIV/Vₜₕ currently. A subsequent channel rotation process occurs between an A channel and a B channel, and an OWG will enter the waiting queue due to the rotation that occurs when the maximum threshold is exceeded.

For the subsequent channel rotation process illustrated in FIG. 7C, two points should be noted.

1. when the channel threshold is large enough, if a newly added OWG is allocated in a channel that has been allocated to an operating OWG, the traffic load efficiency of the radio network of the original operating OWG will reduced due to a co-channel competition. As illustrated in FIG. 7C, when OWG4 and OWG5 are allocated to the sixth channel, the efficiency of OWG that has been originally allocated to the sixth channel is reduced because of its influence.

2. the channel rotation in this setting of the channel threshold usually occurs between an OWG operating in an A channel and an OWG operating in a B channel. As illustrated in FIG. 7C, at a certain time, a channel rotation is performed for OWG1 and OWG5. The traffic load efficiency changes accordingly.

A dismiss process of an OWG will be described as follows.

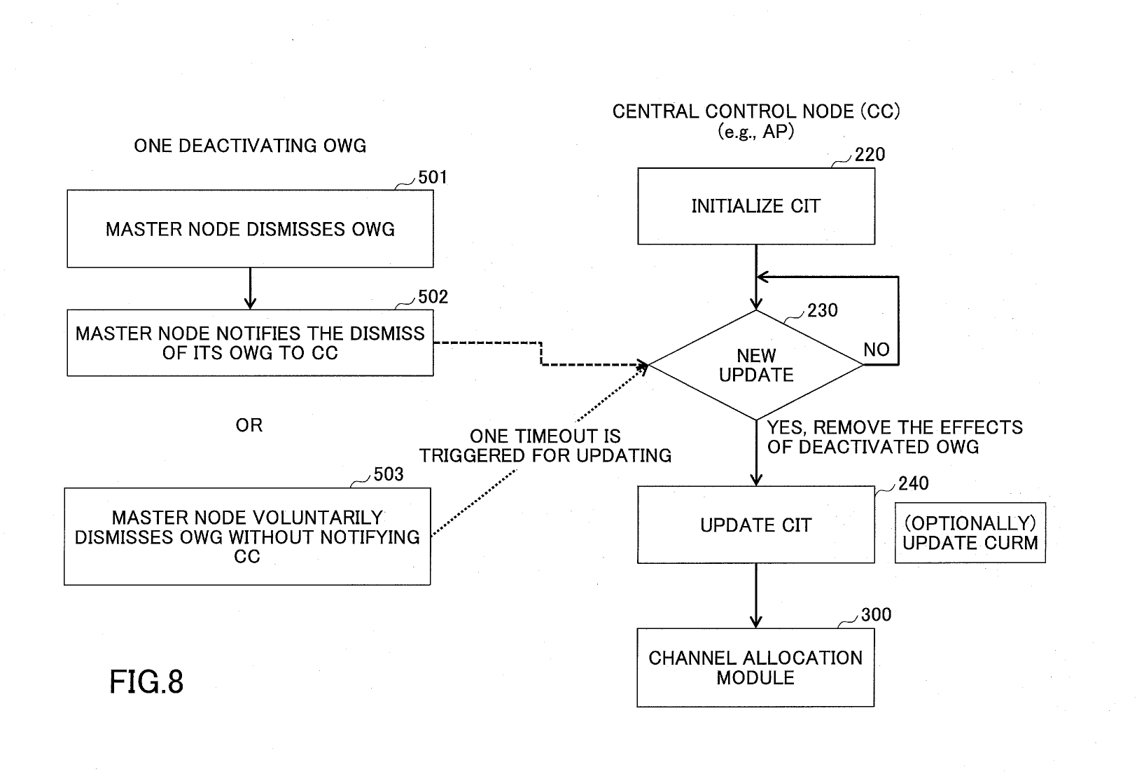

FIG. 8 illustrates a dismiss process of an OWG (the dismiss process is a process that usually occurs in the OWG, and the purpose of the description here is to explain how the method and system for allocating the channel according to the embodiments of the present invention respond when the OWG is dismissed), and the dismiss process is as follows.

(I) when a dismiss is determined, the master node performs the dismiss action, and it is necessary for the master node to cut the connection to the slave node (step 501);

(II) alternatively, notify the central control node that the OWG will be dismissed (and will be dismissed based on the feedback from the central control node) (step 502);

(III) alternatively, directly leave from the system (step 503); and the central control node may periodically poll the active status of OWGs, and it is understood that the OWG has been dismissed and left from the system if an OWG cannot be detected in a predetermined time segment;

(IV) when the OWG has left the system, it is necessary for the central control node to perform a subsequent operation, for example, updating the CIT and updating CURM (step 230).

From the above, the central control node performs many management operations, such as detecting and updating the CIT, receiving channel allocation/rotation request, channel allocation/rotation, a subsequent operation after OWG dismiss, etc. In fact, the central control node may be another management apparatus or system, and may be located in an OWG, a mobile equipment, a control station, etc., and the position and the implementation method are not limited.

In the above embodiments, the utilization rate of the sharing channel can be increased by a dynamic allocation of A channels and B channels; and the available utilization rate and the fairness of the channels can be flexibly adjusted by setting channel interference thresholds. Important data (such as large data and data needed to be high-speed transmitted) can be transmitted efficiently by the classification of A channels and B channels, and OWGs in the system can also be rotated to the B channels with higher efficiency and a higher speed as needed. Therefore, the temporary transmission of large data and the temporary high-speed transmission can be realized.

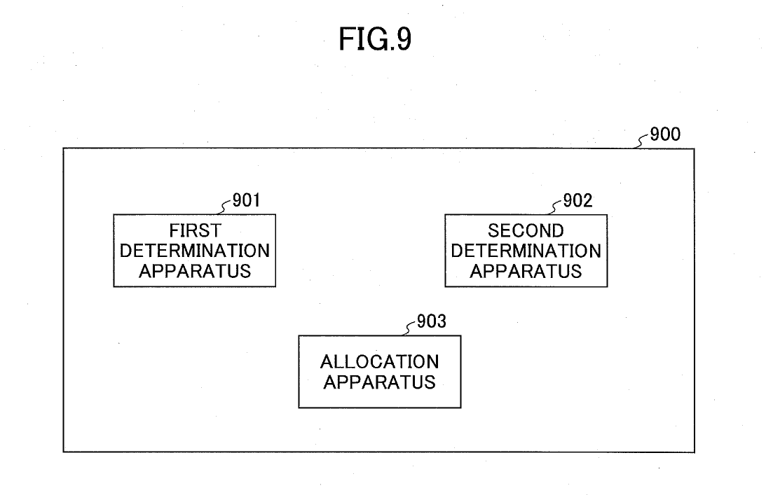

FIG. 9 is a block diagram illustrating a system for allocating a radio channel 900 according to another embodiment of the present invention.

The radio channel allocation system 900 includes a first determination apparatus 901 configured to determine one or more priority radio channels exclusively for transmitting priority data; a second determination apparatus 902 configured to determine whether there is a condition of allocating the priority radio channel in an organized wireless group (OWG); and an allocation apparatus 903 configured to allocate one of the priority radio channels, when the one or more priority radio channels are empty.

In an embodiment, the condition of allocating the priority radio channel includes at least one of the conditions that (1) there is priority transmission data between two radio mobile equipments, wherein the priority transmission data is transmitted by the allocated priority radio channel, (2) it is necessary to allocate the priority radio channel to a newly added OWG that does not have an allocated channel, (3) it is necessary to allocate the priority radio channel in an OWG, (4) an interference value of an existing mobile equipment or OWG is greater than a predetermined value, and (5) there is a request for the allocation of the priority radio channel from an OWG with an allocated channel. It should be noted that, the condition of allocating the priority radio channel is not limited to the above conditions. The interference value of the above OWG may be represented by at least one of a co-channel interference value, a spectrum utilization rate, a real-time packet loss rate, an average transmission delay and a radio transmission path loss.

In an embodiment, the first determination apparatus 901 may find one or more radio channels with a utilization rate less than a first predetermined threshold from all of the available radio channels as the one or more priority radio channels.

In an embodiment, the utilization rate of the radio channel is determined from at least one of a spectrum utilization rate of the radio channel, a co-channel interference indication value of the radio channel, the number of access equipments of the radio channel, and an average packet loss rate of the radio channel. It should be noted that, the utilization rate of the radio channel may also be determined by other factors, as long as such factors can reflect the situation of occupation and interference of the radio channel.

In this way, all of the available radio channels may be divided, based on the situation of occupation and interference of the radio channel, into at least two types of channels: common channels that allow strong interference (A channels), and channels with weak interference or without an interference, that consist of priority radio channels exclusively for transmitting the priority data (B channels).

In an embodiment, the first determination apparatus 901 may perform the determination under one of the conditions that: a first predetermined time period has elapsed; it is necessary to transmit the priority transmission data; there is a newly added OWG; and interference of an OWG is greater than a predetermined value. That is to say, for example, the priority radio channels exclusively for transmitting the priority data may be redefined periodically (for example, once every three days or a week) based on the situation of occupation and interference (for example, the spectrum utilization rate of the radio channel) of each of the current radio channels. Thus, the priority radio channels exclusively for transmitting the priority data can always suit the current situation.

The data with priority required for transmission (the priority transmission data) may be, for example, a video, a picture or important data for sharing to be transmitted between two mobile equipments in a Wi-Fi network or an OWG, and usually, it is necessary to ensure transmitting the priority data more securely and efficiently than other common data. Therefore, it is necessary to allocate an exclusive channel to the priority data so as to perform a transmission securely at a high-speed.

In an embodiment, the condition of allocating the priority radio channel, which is used in the second determination apparatus 902, may include at least one of the conditions that (1) there is priority transmission data between two radio mobile equipments, the priority transmission data being transmitted by the allocated priority radio channel, (2) it is necessary to allocate the priority radio channel to a newly added OWG, (3) it is necessary to allocate the priority radio channel in an OWG, (4) an interference value of an existing mobile equipment or OWG is greater than a predetermined value, (5) there is a request for the allocation of the priority radio channel from an OWG with an allocated channel, and (6) there is an OWG that is waiting for the allocation of the priority radio channel in a waiting queue.

In an embodiment, the radio channel allocation system 900 may further include an apparatus (not shown) for allocating the following channels other than the one or more priority radio channels to the priority transmission data when the one or more priority radio channels are not empty: (1) a radio channel with a minimum co-channel interference indication value, (2) one of the radio channels with a co-channel interference indication value less than a second predetermined threshold, (3) a radio channel with a minimum ratio of a co-channel interference indication value to a co-channel interference threshold, and (4) a radio channel with a minimum ratio of a co-channel interference indication value to a co-channel interference threshold, the ratio being less than 1. That is to say, if there is no available priority radio channel, the channel with a minimum co-channel interference indication value in the common radio channels other than the priority radio channels may be allocated to the priority transmission data. It should be noted that, in an embodiment of such step, the reason for setting the co-channel interference threshold is that, for example, a common channel with strong interference is not allocated to the priority data. If all of the co-channel interference values of the common channels are greater than the co-channel interference threshold, it means that all of the interferences of common channels are too strong. In this case, if a common channel with a strong interference is allocated to the priority data, the speed and quality of transmission of the priority data will be greatly reduced. Accordingly, the priority data may be put into a waiting queue to wait for the earliest priority radio channel which the transmission of the priority data completes, an empty priority radio channel or a common channel with a minimum co-channel interference indication value less than the co-channel interference threshold.

In an embodiment, the co-channel interference indication value may be obtained by calculating co-channel interference values of mobile equipments using a specific radio channel, and calculating a weighted average value of the calculated co-channel interference values by corresponding weighting factors to obtain the co-channel interference indication value of the specific radio channel. The co-channel interference values of mobile equipments are calculated by one or more of a real-time packet loss rate, an average transmission delay and a radio transmission path loss of mobile equipments using the same radio channel. It should be noted that, the co-channel interference indication value of a radio channel may also be calculated by other parameters, and the description thereof is omitted here since it is a known technology.

In an embodiment, the allocation apparatus 903 may terminate the allocation of the priority radio channel when one of the following situations occurs: (1) a predetermined time period has elapsed; (2) the transmission of priority data is completed; and (3) a request for terminating the allocation of the priority radio channel has been received. In an embodiment, the priority radio channel may be allocated to only one transmission of the priority data every time, that is to say, only one transmission of the priority data may be performed by the priority radio channel every time. In this way, the effect of the bandwidth occupation and the transmission interference of other data on the transmission of the priority data can be reduced, therefore, a transmission with low bit error rate can be performed more securely and efficiently and the priority data can be transmitted at a high speed. It should be noted that, the number of the priority data which the priority radio channel transmits may also be determined, or a threshold of a utilization rate of the priority radio channel (such as a threshold of a spectrum utilization rate, a threshold of the co-channel interference value, etc.) may be determined, so as to transmit as much priority data with the range of the threshold of the utilization rate by the priority radio channel.

In an embodiment, the priority transmission data may be transmitted between the mobile equipments in the OWG. In an embodiment, all of the mobile equipments in an OWG may perform a communication with each other by one of the allocated priority radio channels, after the one or more priority radio channels are allocated to the OWG. It should be noted that, in the present embodiment, the OWG may be a network that is organized by the users themselves and includes a number of the mobile equipments. In such network, a mobile equipment (as a master node) may manage other mobile equipments (as slave nodes), for example, the entering of the node to the OWG, the leaving of the node from the OWG, the authentication of the slave node, a request of channel allocation to an radio access equipment, the channel allocation to nodes, the collection of the co-channel interference values of the mobile equipments in the OWG, the sending of the co-channel interference values, etc. Accordingly, the mobile equipments in such OWG are different from sparse mobile equipments in a Wi-Fi environment. It should be noted that, in an embodiment, the priority transmission data is not the data transmitted between any two mobile equipments in a common Wi-Fi network, but the data transmitted between two (or more) mobile equipments in such OWG. Additionally, in another embodiment, all of the mobile equipments in an OWG may perform a communication with each other by one of the allocated priority radio channels, after the one or more priority radio channels are allocated to the OWG; that is to say, in such embodiment, when a priority radio channel has been allocated to the OWG (for example, by a request for allocating a radio channel from a master node in the OWG), all of the mobile equipments in the OWG can transmit the data securely and efficiently with a low bit error rate by using the allocated priority radio channel. In this way, the allocation of the priority radio channel can be applied to the OWG creatively, and a new allocation method of the priority radio channel in OWG can be provided.

In an embodiment, the OWG may include a region limited network. Authenticated mobile equipments in the region limited network can communicate with each other, and the authenticated mobile equipments in the region limited network cannot communicate with unauthenticated mobile equipments or another mobile equipment on the outside of the region limited network. The region limited network may also represent a region where the range can be uniquely determined by a physically controlling method or an arbitrarily adjustment. Similarly to a P2P network with a plurality of mobile equipment nodes, the authenticated mobile equipments in the region limited network can communicate with each other, and the authenticated mobile equipments in the region limited network cannot communicate with the unauthenticated mobile equipments or another mobile equipment on the outside of the region limited network. As an example, the limited region includes a region uniquely determined by a range of infrared rays emitted by one or more light emitters (the lights emitted by the light emitters have a good directivity, and preferably, are the lights of light emitting diodes (LEDs)), a region uniquely determined by a range of microwaves emitted by one or more microwave emitters, a limited region of the near field communication (NFC) technology and a limited region covered by other signals, but is not limited thereto. For example, a detailed description of the self-organized P2P network of a limited region may be referred to in the pending Chinese Application No. 201310056656.0 filed on Feb. 22, 2013 and the pending Chinese Application No. 201310176417.9 filed on May 14, 2013 for which the inventors are the same as the present application, and the entire contents of which are hereby incorporated by reference.

Thus, it is possible to allocate a priority radio channel temporarily to data with priority required for transmission or an organized wireless network. Accordingly, a high-speed transmission with low bit error rate can be performed more securely and efficiently, compared with the case where a common radio channel is allocated. Therefore, for example, important data or data in an organized wireless group (OWG) can be transmitted at a high speed.

The block diagrams of the units, apparatuses, devices and system are just examples, the connection, placement and configuration illustrated in the block diagrams related to the present invention are not limited to these examples, and the units, apparatuses, devices and system may be connected, placed or configured in any way. The terms “comprise”, “include” and “have” are open-form terms, which mean and may be changed into “include and is not limited to”. The term “or” and “and” means and may be change into “and/or”, unless the context is clearly not. The term “such as” means and may be changed to “such as, but not limited to”.

The flowchart and the method according to the present invention are juste examples, and not limited to the steps in the embodiments. The steps of the embodiments may be performed in any orders. The terms “next”, “subsequently” and “then” are just for describing the present invention, and the present invention is not limited to these terms. Furthermore, the articles “a”, “an” and “the” should not be limited to the singular element.

The basic principle of the present invention is described above with reference to the embodiments, however the present invention is not limited to the principle.

The purposes of the present invention is described above. The above descriptions of the embodiments are just examples, and various modifications, replacements or combinations may be made without departing from the scope of the present invention by persons skilled in the art.

The steps of the above method may be performed by any appropriate means that can perform the corresponding functions. The means may include any components and/or modules of hardware and/or software, and include but not be limited to a circuit, a dedicated integrated circuit (ASIC) or a processor.

The present invention may use a general-purpose processor, a digital signal processor (DSP), an ASIC, field programmable gate array signals (FPGA) or other programmable logic device (PLD), a discrete gate or transistor logic, discrete hardware components or any other combination for executing the functions to realize the logic blocks, modules and circuits of the embodiments. The general-purpose processor is a micro-processor, and alternatively, the processor may be any processors, controllers, micro-controllers or state machines that can be obtained commercially. The processor may also be the combination of the computer equipments, such as the combination of a DSP and a micro-processor, the combination of plural micro-processors, the combination of a DSP and plural micro-processors.

The steps of the method according to the present invention may be incorporated in the hardware, software modules performed by a processor or the combination of these two directly. The software modules may be recorded in a recording medium with any shapes. The examples of the recording medium includes a random access memory (RAM), a read-only memory (ROM), a flash memory, an EPROM memory, an EEPROM memory, a register, a hard disk drive, a removable disk, a CD-ROM, etc. The recording medium may be linked to a processor so that the processor reads information from the recording medium or writes information into the recording medium. Alternatively, the recording medium and the processor may also be a whole apparatus. The software module may be a single command or many commands, and may be distributed in several code segments, different programs or plural recording media.

Steps of the above method may be performed in time order, however the performing sequence is not limited to the time order. Any steps may be performed in parallel or independently.

The functions may be realized by hardware, software, firmware or any combination thereof. When the function is implemented by software, the function may be stored in a computer-readable medium as one or more commands. The recording medium may be any real media that can be accessed by a computer. Such computer-readable medium includes a RAM, a ROM, an EEPROM, a CD-ROM or other laser disc, a magnetic disk or other magnetic memory, or other any real media that carry or store commands, data or program codes and are accessed by the computer. Such disk and disc include a CD, a laser disc, an optical disc, a DVD disc, a floppy disk and a blue-ray disc, and the disk usually reproduces data and the disc reproduces data by a laser.

Thus, the operations may be performed by a computer program product. For example, such computer program product may be a tangible medium where computer-readable commands are stored (or coded) in, and the commands may be performed by one or more processors to perform the operation. The computer program product may include packaging material.

The software or command may also be transmitted by a transmission medium. For example, an axial cable, an optical cable, a twisted cable, a digital subscriber line (DSL), or a transmission medium of the wireless technology of the infrared, wireless or microwave may be used to transmit the software from a website, a server or other remote source.

Additionally, the modules and/or other appropriate means of the method or technology may be obtained from a user terminal and/or base station, or by other methods. For example, such equipment may be connected to a server so as to perform the transmission of the means of the above method. Alternatively, the methods may be provided via a storage unit (for example, a physical storage medium such as a RAM, a ROM, a CD or a floppy disc), so that the user terminal and/or the base station can obtain the methods when it is connected to the equipment. Furthermore, other any appropriate technology may be provided to the equipment by the method.

The present specification and the appended claims includes other examples and implementations. For example, the above functions may be implemented by a processor, hardware, software, firmware, hard-wire or any combination thereof. The features for implementing the functions may be located at any physical position where which is distributed to each position physically. Furthermore, the term “or” before the term “at least one” means a separate enumerating, and for example, “at least one of A, B or C” means (1) A, B or C, (2) AB, AC or BC, or (3) ABC (namely, A and B and C). Additionally, the term “example” does not mean a preferable example or an example superior to other examples.

Various modifications, replacements or combinations may be made without departing from the scope of the present invention by persons skilled in the art. Furthermore, the scope of the present specification and the claims are not limited to the above processing, machine, manufacture, composition of events, means, method and operation. The processing, machine, manufacture, composition of events, means, method and operation with a similar function or a similar result may also be applied to the present invention. Therefore, the scope of the appended claims include such processing, machine, manufacture, composition of events, means, method and operation.

The present application is based on and claims the benefit of priority of Chinese Priority Application No. 201310319684.7 filed on Jul. 26, 2013, the entire contents of which are hereby incorporated by reference.

What is claimed is:

1. A method for allocating a radio channel, the method comprising the steps of:
determining one or more priority radio channels exclusively for transmitting priority data;
determining whether there is a condition of allocating the one or more priority radio channels in an organized wireless group (OWG); and
allocating one of the one or more priority radio channels, when the one or more priority radio channels are empty.

2. The method for allocating a radio channel according to claim 1,
wherein the condition of allocating the one priority radio channel includes at least one of the conditions that
there is priority transmission data to be transmitted between two radio mobile equipments, wherein the priority transmission data is transmitted by the allocated priority radio channel,
it is necessary to allocate the one priority radio channel to a newly added OWG,
it is necessary to allocate the one priority radio channel in an OWG,
an interference value of an existing mobile equipment or OWG is greater than a predetermined value,
there is a request for the allocation of the one priority radio channel from an OWG with an allocated channel, and
there is an OWG that is waiting for the allocation of the one priority radio channel in a waiting queue.

3. The method for allocating a radio channel according to claim 1,
wherein the step of determining the one or more priority radio channels exclusively for transmitting priority data includes
finding one or more radio channels with a utilization rate less than a first predetermined threshold from all of the available radio channels as the one or more priority radio channels.

4. The method for allocating a radio channel according to claim 3,
wherein the utilization rate of the radio channel is determined from at least one of a spectrum utilization rate of the radio channel, a co-channel interference indication value of the radio channel, the number of access equipments of the radio channel, and an average packet loss rate of the radio channel.

5. The method for allocating a radio channel according to claim 3,
wherein the step of determining the one or more priority radio channels exclusively for transmitting priority data occurs under one of the conditions that:
a first predetermined time period has elapsed;
it is necessary to transmit the priority transmission data;
there is a newly added OWG; and
interference of an OWG is greater than a predetermined value.

6. The method for allocating a radio channel according to claim 1, further comprising allocating the following channels other than the one or more priority radio channels to the priority transmission data when the one or more priority radio channels are not empty:
a radio channel with a minimum co-channel interference indication value,
one of the radio channels with a co-channel interference indication value less than a second predetermined threshold,
a radio channel with a minimum ratio of a co-channel interference indication value to a co-channel interference threshold, and
a radio channel with a minimum ratio of a co-channel interference indication value to a co-channel interference threshold, the ratio being less than 1.

7. The method for allocating a radio channel according to claim 6,
wherein the co-channel interference indication value is obtained by
calculating co-channel interference values of mobile equipments using a specific radio channel, and
calculating a weighted average value of the calculated co-channel interference values by corresponding weighting factors to obtain the co-channel interference indication value of the specific radio channel,
wherein the co-channel interference values of mobile equipments are calculated by one or more of a real-time packet loss rate, an average transmission delay and a radio transmission path loss of mobile equipments using the same radio channel.

8. The method for allocating a radio channel according to claim 1,
wherein all of the mobile equipments in an OWG perform a communication with each other by the allocated one or more priority radio channels, after the one or more priority radio channels are allocated to the OWG.

9. The method for allocating a radio channel according to claim 2,
wherein the OWG includes a region limited network,
wherein authenticated mobile equipments in the region limited network can communicate with each other, and the authenticated mobile equipments in the region limited network cannot communicate with unauthenticated mobile equipments or another mobile equipment on the outside of the region limited network.

10. A system for allocating a radio channel, the system comprising:
a first determination apparatus configured to determine one or more priority radio channels exclusively for transmitting priority data;
a second determination apparatus configured to determine whether there is a condition of allocating the one or more priority radio channels in an organized wireless group (OWG); and
an allocation apparatus configured to allocate one of the one or more priority radio channels, when the one or more priority radio channels are empty.
